(19) United States
(12) Patent Application Publication
(10) Pub. No.: US 2025/0175739 A1
(43) Pub. Date: May 29, 2025

(54) AUDIO ENTERTAINMENT SYSTEM

(71) Applicant: Nokia Technologies Oy, Espoo (FI)

(72) Inventors: Jussi Artturi LEPPÄNEN, Tampere (FI); Arto Juhani LEHTINIEMI, Tampere (FI); Miikka Tapani VILERMO, Tampere (FI)

(21) Appl. No.: 18/955,220

(22) Filed: Nov. 21, 2024

(30) Foreign Application Priority Data
Nov. 27, 2023 (GB) 2318048.2

(51) Int. Cl. H04R 3/12

(52) U.S. Cl. CPC H04R 3/12; H04R 2420/01; H04R 2430/01; H04R 2499/13

(57) ABSTRACT

There is herein provided an apparatus comprising means for receiving, from a first user, a first audio signal command. The apparatus further comprises means for determining a location of the first user in an environment and means for selecting at least a first loudspeaker from a plurality of loudspeakers located in the environment, the at least first loudspeaker being one or more loudspeakers in closest physical proximity to the first user. The apparatus further comprises means for modifying an audio output from at least one loudspeaker from the plurality of loudspeakers, such that the at least first loudspeaker has a different audio output to a remainder of the plurality of loudspeakers.

### FIELD

Example embodiments may relate to systems, methods and/or computer programs for audio entertainment. In particular, example embodiments relate to multi-user audio entertainment apparatus for a vehicle.

### BACKGROUND

The disclosure herein relates to rendering multi-user selected content, for example, a jointly created playlist. The multi-user content may be implemented in an automotive vehicle or other environment.

Collaborative playlists are playlists that allow multiple different users to add songs to the same playlist. Collaborative playlists typically label songs according to which user they have been added by, however, there is required an interactive way of denoting which user added the song to the playlist which does not require a user to check a user interface.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising means for: receiving, from a first user, a first audio signal command; means for determining a location of the first user in an environment; means for selecting at least a first loudspeaker from a plurality of loudspeakers located in the environment, the at least first loudspeaker being one or more loudspeakers in closest physical proximity to the first user; and means for modifying an audio output from at least one loudspeaker from the plurality of loudspeakers, such that the at least first loudspeaker has a different audio output to a remainder of the plurality of loudspeakers.

In some embodiments, modifying an audio output from at least one loudspeaker comprises modifying an audio output from the at least first loudspeaker of the plurality of loudspeakers.

In some embodiments, modifying the audio output from the at least first loudspeaker comprises changing at least one feature of the audio output.

In some embodiments, the at least one audio feature comprises at least one of the following: volume, bass, treble, balance, equalisation parameters.

In some embodiments, the apparatus further comprises means for modifying a second audio output from at least a second loudspeaker of the plurality of loudspeakers, wherein the second audio output is modified such that is different to the audio output.

In some embodiments, modifying the audio output from the at least first loudspeaker comprises playing a specific piece of audio.

In some embodiments, the specific piece of audio comprises at least one piece of audio selected by the first user.

In some embodiments, modifying the audio output from the at least first loudspeaker comprises playing, pausing, muting, unmuting, rewinding or fast-forwarding the audio output.

In some embodiments, the apparatus further comprises means for ranking each of the plurality of loudspeakers according to the proximal physical distance from the first user to produce a list and means for implementing the first audio signal command according to the order of the list.

In some embodiments, the apparatus further comprises: means for receiving a second audio signal command from a second user; means for determining that the second user is remote from the audio entertainment system such that the second user is not located within the environment; means for modifying the audio output from at least one loudspeaker based on the second audio signal command; and means for implementing an audio indicator based on the determination that the second user is remote from the audio entertainment system.

In some embodiments, the audio indicator comprises at least one of: a sound effect, and/or a change in at least one audio feature, and/or a filter implemented over the audio output.

In some embodiments, the apparatus further comprises means for informing the second user that the second audio signal command has been implemented.

In some embodiments, the means for determining a location of a first user in an environment, comprises means for determining a location of a first device in the environment, wherein the first device is associated to the first user.

In some embodiments, the means for determining the location of the first user in the environment comprises at least one of the following: informing the audio entertainment system of the location of the first device in the environment by user command; using radio signal-strength based triangulation to determine the location of the first device in the environment; using Bluetooth and/or Bluetooth Low Energy signal-strength based triangulation to determine the location of the first device in the environment; or using Ultra Wide Band positioning technology to determine the location of the first device in the environment.

In some embodiments, the means for determining a location of the first user in an environment, comprises at least one camera configured to locate the position of the first user.

In some embodiments, determining that the first loudspeaker is one or more loudspeakers in closest proximity to the first user is based on the determined location of a first device in the environment and positions of loudspeakers in the environment.

In some embodiments, the first audio signal command is received from a remote location from the audio entertainment system such that the second user is not located within the environment.

In some embodiments, the apparatus is an audio entertainment system or comprises an audio entertainment system.

In some embodiments, the apparatus is for a vehicle and the environment comprises the inside of the vehicle.

According to a second aspect, there is described a method comprising: receiving, from a first user, a first audio signal command; determining a location of the first user in an environment; selecting at least a first loudspeaker from a plurality of loudspeakers located in the environment, the at least first loudspeaker being one or more loudspeakers in closest physical proximity to the first user; and modifying an audio output from at least one loudspeaker from the plurality of loudspeakers, such that the at least first loudspeaker has a different audio output to a remainder of the plurality of loudspeakers.

According to a third aspect, there is provided a computer program product comprising a set of instructions which, when executed on an apparatus, is configured to cause the apparatus to carry out the method of any preceding method definition.

According to a fourth aspect, there is provided a non-transitory computer readable medium comprising program instructions stored thereon for performing a method, comprising: receiving, from a first user, a first audio signal command; determining a location of the first user in an environment; selecting at least a first loudspeaker from a plurality of loudspeakers located in the environment, the at least first loudspeaker being one or more loudspeakers in closest physical proximity to the first user; and modifying an audio output from at least one loudspeaker from the plurality of loudspeakers, such that the at least first loudspeaker has a different audio output to a remainder of the plurality of loudspeakers.

The program instructions of the fourth aspect may also perform operations according to any preceding method definition of the second aspect.

### BRIEF DESCRIPTION OF THE DRAWINGS

Example embodiments will now be described by way of non-limiting example, with reference to the accompanying drawings, in which:

FIG. 1 is a schematic diagram of a system which controls output of content to users;

FIG. 2 is a view of a schematic diagram of an audio entertainment system;

FIG. 3 is a schematic diagram of a system according to a first embodiment;

FIG. 4 is a schematic diagram of a system according to a second embodiment;

FIG. 5 is a flow diagram illustrating method steps that may be performed by an apparatus according to one or more example embodiments;

FIGS. 6A and 6B show schematic diagrams of a system according to a third embodiment;

FIG. 7 is a schematic diagram of a system according to a fourth embodiment;

FIG. 8 is a schematic diagram of a system according to a fifth embodiment;

FIG. 9 is a schematic diagram of a system according to a sixth embodiment;

FIG. 10 shows an apparatus according to one or more example embodiments; and

FIG. 11 shows a non-transitory medium for storing computer-readable code or instructions which, when executed by an apparatus, may perform processing operations described herein.

Like reference numerals between figures indicate the same features.

### DETAILED DESCRIPTION

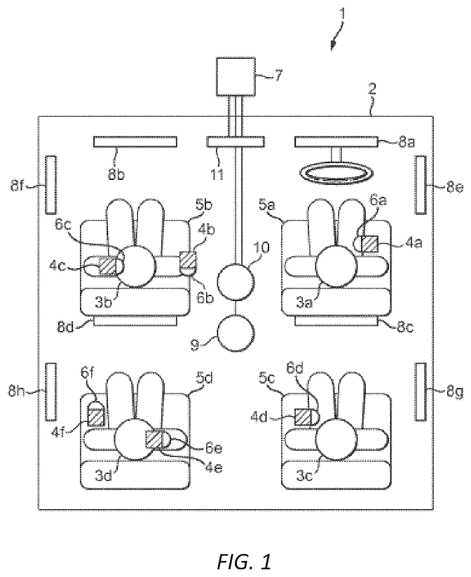

Referring to FIG. 1, a system 1 is illustrated which controls output of audio and visual content within an environment (e.g. a vehicle 2) for accommodating users 3a, 3b, 3c, 3d, which in this example comprises the interior of a vehicle such as a car or automobile, based on determined information concerning the location of one or more user devices 4a, 4b, 4c, 4d, 4e, 4f within the environment.

In this example, the interior of the vehicle 2 comprises a driver seat 5a, a front passenger seat 5b, a right rear passenger seat 5c and a left rear passenger seat 5d.

Each of the user devices 4a-f may comprise a Bluetooth transmitter or radio tag 6a, 6b, 6c, 6d, 6e, 6f configured to transmit a wireless signal from which the location of the device within the interior of the vehicle 2 can be determined, as described in more detail hereinafter.

The user devices 4a-f may be configured to receive audio and/or visual content depending on their location within the environment (e.g. a vehicle 2), and some of them may also be configured to output content to be experienced by users in the environment 2.

The system 1 comprises a controller 7, output devices (i.e. visual or audio outputs) 8a, 8b, 8c, 8d, 8e, 8f, 8g, 8h, a receiver 9, a transceiver 10 and a user interface 11.

The output devices 8a-h are located at different locations within the interior of the vehicle 2 and are configured to output audio or visual content for experience by users. Output devices 8a-d are display screens, and output devices 8e-h are loudspeakers. Of the output devices 8e-h, each display and loudspeaker may be configured to output primarily to a different respective seat 5a-d. For example, display 8b and speaker 8f are configured to output primarily to the front passenger seat 5b. The displays 8c, 8d configured primarily to output to each of the back seats 5c, 5d respectively are head rest mounted displays.

The receiver 9 is configured to receive the wireless signals transmitted by the tags 6a-f of the user devices 4a-f. The receiver 9 may be located in the centre of the car ceiling such that it has sufficient visibility of each user seating position 5a-d. The transceiver 10 is configured to communicate with the user devices 4a-f via the radio tags 6a-f. The user interface 11 may for example comprise a touch screen. The controller 7 is configured to interface with and control the output devices 8e-h, the receiver 9, the transceiver 10 and the user interface 11. The receiver 9 and the transceiver 10 may conveniently be configured as a single unit.

The user devices 4a-f may be portable user devices, for example a smartphone, a tablet computer, a smart watch, digital assistant, wearable computer or head mounted device (HMD). This list is not exhaustive. The user device may also comprise loudspeakers. User devices may be capable of establishing a communications session with one or more other user devices, servers and/or nodes via a communications network. A user device may be configured to transmit and receive data using protocols for 3G, 4G, LTE, 5G or any future generation communication protocol. A user device may comprise means for short-range communications using, for example, Bluetooth, Zigbee or WiFi. The user device may comprise one or more antennas for communicating with external devices, for example one or more other remote user devices and/or one or more remote servers and/or one or more communications nodes of a network.

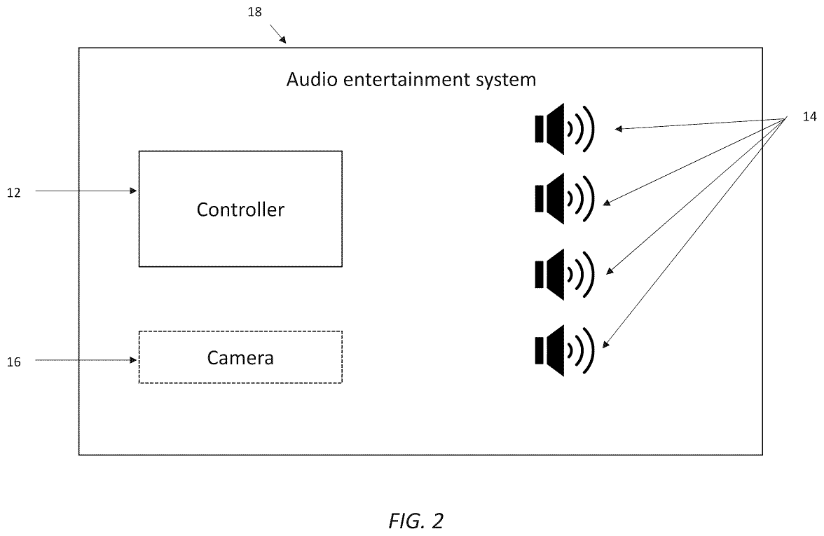

FIG. 2, shows a simplified version of the system of FIG. 1. FIG. 2. shows an audio entertainment system 18 comprising a controller 12, a series of loudspeakers 14 and, optionally, a camera 16.

The disclosure herein relates to rendering multi-user selected content (e.g. jointly created playlist) in an environment. The environment may be an automotive setting such as a vehicle 2, however, the disclosure is equally applicable to other environments such as a room or any multi-loudspeaker enabled space. The example use case of musical playlist or radio channel may be used as a reference but the disclosure is not limited to these examples herein. In particular, the present disclosure may also relate to dual audio-visual content.

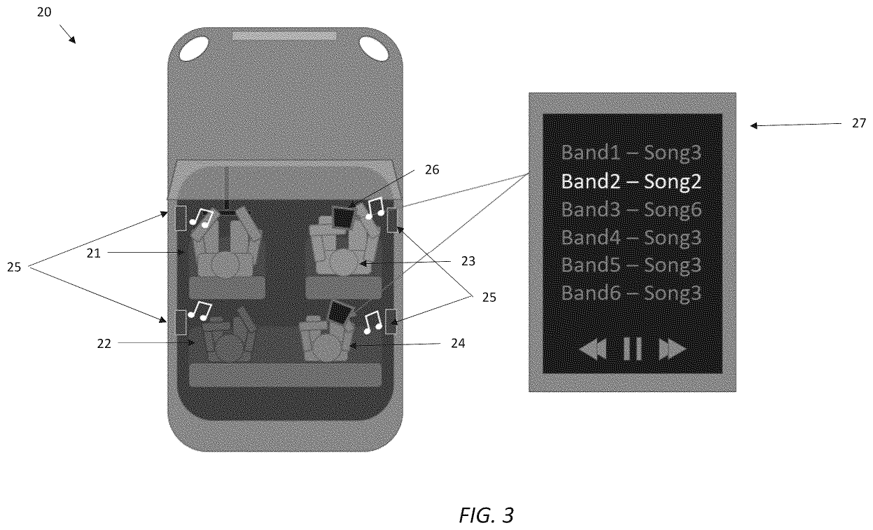

FIG. 3 shows an example situation where the proposed invention is applicable. A group of users 21, 22, 23, 24 located in an environment (e.g. are travelling in a car 20). The users 21, 22, 23, 24 are listening to an audio output from at least one loudspeaker 25. The audio output comprises an audio output list 27. The audio output list 27 may, for example, comprise a playlist of songs, radio channels or a list of podcasts. The audio output list 27 may be jointly created before a journey in the car 20 or whilst the group of users 21, 22, 23, 24 are on the journey. FIG. 3 demonstrates four users 21, 22, 23, 24 however, there may optionally be fewer or more users 21, 22, 23, 24 in the car 20.

The audio output list 27 comprises metadata information about the selected audio output (e.g. songs, podcasts, radio channels etc). The metadata information includes information about which user 21, 22, 23 or 24 selected each audio output (e.g. who added a song to a playlist). The metadata information can include: Artist, Album, Track title, Genre, Album artwork and Track number.

One or more of the users 21, 22, 23, 24 connects their device to the car 20 audio entertainment system 18 and the audio is output using the audio entertainment system 18. The audio output is played from one or more loudspeakers 25 in the car 20.

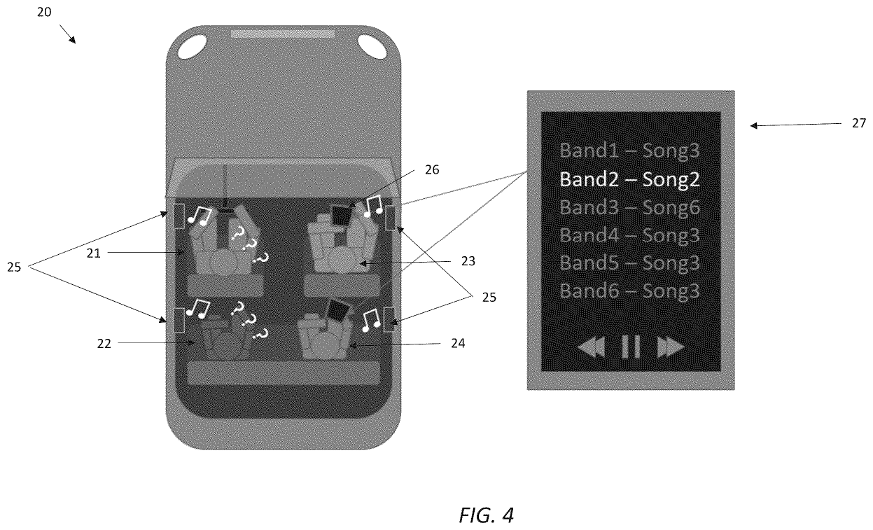

FIG. 4 shows a problem that the disclosure herein aims to address. When, for example, a song is played from the loudspeakers 25 in the car 20, it may not be known, or perhaps it is forgotten, who added a song to the audio output list 27 (e.g. the playlist). This may create confusion among the users of the car 20 as it is not clear who added the song. Traditionally, a user would check on their user device to determine who added the song to the playlist, however, that is not possible for the driver and is also extra hassle for the other people in the car. The disclosure herein aims to make content consumption more immersive, transparent and entertaining. Furthermore, it is desirable to have a safer system for immersive audio entertainment in a car which requires less frequent use of a user interface and user devices, in particular, for the driver. It is also useful to know in real-time situations who is in control of, for example, a playlist, to allow multi-user interactions to a software or service.

Joint content consumption is becoming increasingly popular but not all of the methods provide optimal content consumption experience or a safe method interaction with joint content consumption for a driver.

The disclosure herein proposes modifications to audio playback in a loudspeaker environment based on multi-user interactions related to the content. The audio playback modifications are done based on loudspeaker and user positions with the aim of indicating, in a multi-user environment, who (and/or how) has interacted with, selected or modified the content.

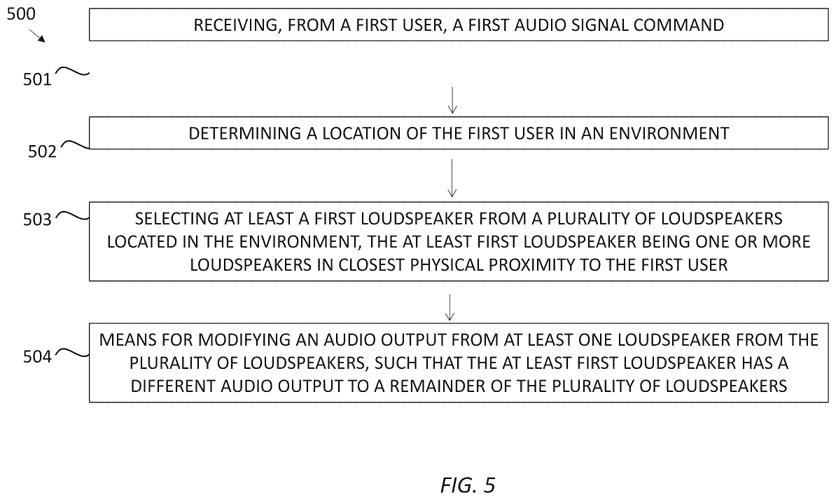

FIG. 5 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 500 comprises a first operation 501 of receiving, from a first user, a first audio signal command. The first audio signal command may comprise a audio command comprising at least one audio signal which is suitable for output via a loudspeaker. An audio command is a purely audio based command and does not involve any aspect related to visual content. Additionally, or alternatively, the first audio signal command may comprise an audio-visual command. The audio-visual command may comprise a first aspect which related to audio content and a second aspect which relates to video content. The first aspect and second aspect of the audio-visual command are related and may be suitable to be output together. The first aspect may comprise at least one audio signal which is suitable for output via at least of a plurality of loudspeakers and the second aspect may comprise at least one visual signal which is suitable for output via a display screen (which may or may not be a touch screen).

The method 500 comprises a second operation 502 of determining a location of the first user in an environment.

The method 500 comprises a third operation 503 of selecting at least a first loudspeaker from a plurality of loudspeakers. The plurality of loudspeakers are located in the environment. The at least first loudspeaker that is selected is the loudspeaker in closest physical proximity to the first user. The loudspeaker that is determined to be closest physical proximity to the user, is the nearest loudspeaker to the first user. The distance may be calculated by using a user device that is associated with the first user or based on camera tracking of the user in the environment. For example, the distance may be determined based on the position of the first user's head or torso. Determining that the first loudspeaker is the loudspeaker in closest proximity to the first user may be based on the determined location of a first device in the environment and the known positions of loudspeakers in the environment. The loudspeaker positions may be fixed or movable, however, the position of each loudspeaker is always known to the audio entertainment system.

In some embodiments, the third operation 503 may comprise selecting more than one loudspeaker. For example, the first user may be located between two loudspeakers of equidistance. In this scenario, both of the two closest loudspeakers are selected.

The method 500 comprises a fourth operation 504 of modifying an audio output from at least one loudspeaker from the plurality of loudspeakers, such that the at least first loudspeaker has a different audio output to a remainder of the plurality of loudspeakers. The remainder of the plurality of loudspeakers, includes all loudspeakers which are not deemed to be in the closest physical proximity to the first user.

In one embodiment, modifying an audio output may comprise, modifying an audio output from the first loudspeaker based on the first audio signal command. In one embodiment, modifying the audio output from the first loudspeaker may include playing a specific piece of audio. The specific piece of audio may comprise at least one of: a song, a podcast or a radio channel. The specific piece of audio may comprise at least one piece of audio selected by the first user. As such, the specific piece of audio selected by the first user may be output only out of the at least first loudspeaker. Subsequently, other loudspeakers of the plurality of loudspeakers may join the first loudspeaker with outputting the specific piece of audio.

In a further embodiment, modifying the audio output from the first loudspeaker may additionally or alternatively comprise changing at least one feature of the audio. The at least one audio feature may comprise at least one of the following: volume, bass, treble, balance, equalization parameters.

Further options for modifying the audio feature may include:
Volume: For example, raising or lowering the volume for a specified period of time.
Pitch, Treble, Bass: For example, tweaking one of these parameters for a specified period of time.
Delay: For example, a delay may add a repeating echo that fades a little more each time the sound is played.
Reverb: For example, a reverb may add an artificial echo to a track, which makes it sound like the recording was made in a larger space.
Compression: For example, editing the dynamic range of an audio output to make the louder parts quieter and the quieter parts louder.
Equalization: For example, a equalization may include an adjustment in the frequencies of each an audio output to make them sound better when combined.
Panning: For example, placing tracks in the left or right channel. This may create an effect that makes it sound like the tracks are coming from different directions.
Hard Cuts: A first track may cut off abruptly and a second track is suddenly started.
Fades: The volume of a track may gradually increase or decrease from one section of the track to the next.
Crossfades: A crossfade occurs when the end of one track fades out and the beginning of the next is faded in.

In a further embodiment, modifying the audio output from the first loudspeaker may additionally or alternatively comprise playing, pausing, muting, unmuting, rewinding or fast-forwarding the audio output.

Modifying an audio output from at least one loudspeaker from the plurality of loudspeakers, such that the at least first loudspeaker has a different audio output to a remainder of the plurality of loudspeakers may also comprise alternative options.

In one embodiment, modifying an audio output from at least one loudspeaker from the plurality of loudspeakers may comprise, modifying an audio output for all of the plurality of loudspeakers apart from the first loudspeaker (e.g., lowering the volume of all other speakers apart from the first loudspeaker which is left at a previous volume).

In one embodiment, modifying an audio output from at least one loudspeaker from the plurality of loudspeakers may comprise, modifying an audio output for all of the plurality of loudspeakers and modifying an audio output from the first loudspeaker differently (e.g. lowering the volume of all other loudspeakers apart from the first loudspeaker and increasing the volume of the first loudspeaker).

The method 500 may further comprise, modifying a second audio output from at least a second speaker of the plurality of loudspeaker. The second audio output is modified such that is different to the audio output. For example, the audio outputs from speakers further from the first user may e.g. reduce the volume, whilst the volume from the first speaker is maintained or increased. As such, a distinction is realized between the output from the loudspeaker (s0 closest to the user and the remaining loudspeakers in the environment.

The method 500 may be carried out on an apparatus, such as on the audio entertainment system 18 of FIG. 2.

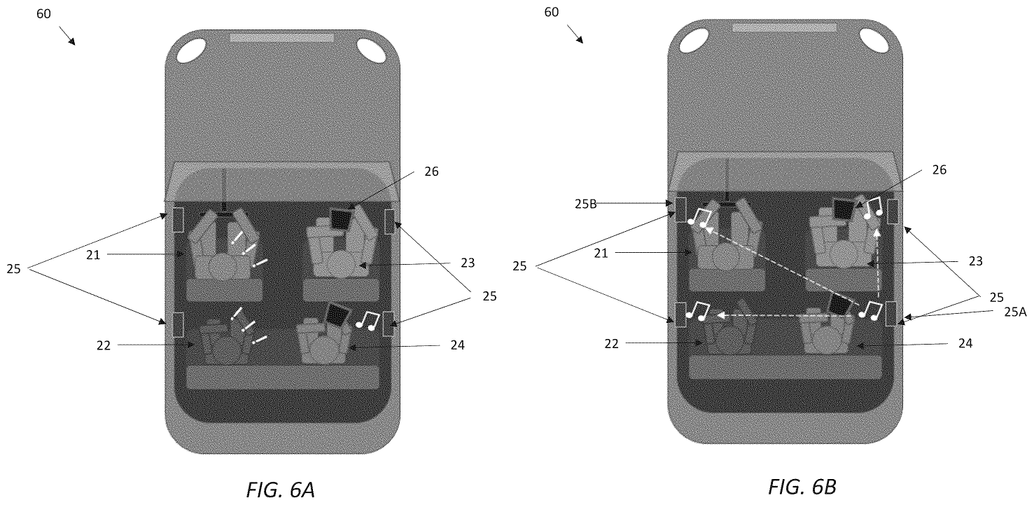

FIG. 6A shows an example system 60 for rendering audio (or any multimedia) content from a jointly created playlist (or other joint feature) in a manner where, when a song starts to play, at first, the song is only played from the loudspeaker closest to a first user 24 that selected that song. The playback is then gradually faded into the other speakers as well and played normally (as shown by the dashed arrows in FIG. 6B).

As such the method 500 may comprise ranking each of the plurality of loudspeakers 25 according to the proximal physical distance from the first user 24 to produce a list. The list may start with the loudspeaker 25A closest to the first user and may end with the loudspeaker 25B furthest from the first user 24. Once the list has been determined, the each of the plurality of loudspeakers are instructed to implement the first audio signal command according to the order of the list. As such the audio output is be expanded according to the proximal physical distance from the first user. For example, the song first begins playing from the loudspeaker 25A closest to the first user 24 and then subsequently the next closest loudspeakers joins in playing the song, until lastly the loudspeaker 25B furthest from the first user 24 joins in playing the song. As such, it is clear to the users in car which user added the song to the playlist without having to check a user interface and instead the information is provided by the features of the audio itself. Such a method can similarly be applied to radio channels, a list of podcasts or any other form of multimedia.

A loudspeaker 25 is assigned to each user and playlist information is passed to a car entertainment system from a mobile device of one of the users in the car. The playlist information contains the song details as well as who added each song to the list (e.g. a User ID). When a new track is played, the system matches the User ID to an assigned loudspeaker for the first user (who selected the song) and starts audio playback from only the assigned loudspeaker. The playback is faded to all loudspeakers gradually over a short period of time (e.g. 2 seconds) and the normal playback is resumed. In some embodiments, more than one loudspeaker may be used to indicate to the location of the user. For example, all of the loudspeakers closest to the user may be used to indicated the location of the user.

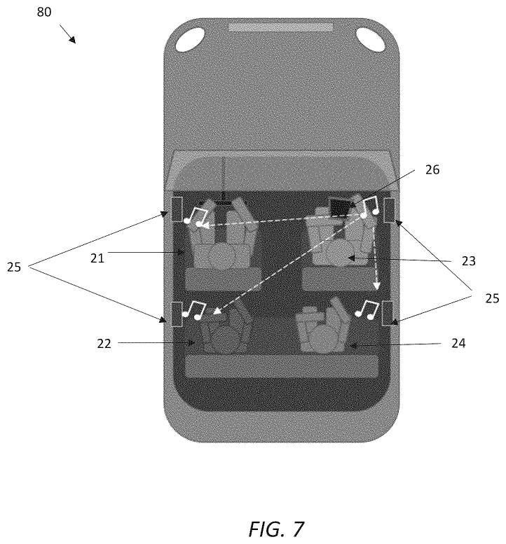

FIG. 7 shows another example connected car entertainment system 70 for rendering audio. The system 70 indicates which user is controlling a software application and may convey this information to all users in real-time. In the case of a multi-user application, such as the connected car entertainment system 70, where multiple users 21, 22, 23, 24 are allowed to control it through their user devices 26, the system 70 indicates in which user is doing the controlling. For example, the user 23 in FIG. 7 is selecting radio channels. When user 23 changes a radio channel, audio is first placed from the loudspeaker 25 closest to them. Additionally, or alternatively, the loudspeaker 25 closest to the user 23 may play a sound effect or initiate a new audio feature (as previously described) to demonstrate to other users 21, 22, 24 in the car which user was controlling the system 70. Such a method can similarly be applied to songs in a playlist, a list of podcasts or any other form of multimedia. The system 70 is as such be capable of providing an audio representation to answer the questions of: “Who changed the volume? Who paused the playback of a video? Who skipped a track? Who changed the radio channel? Who modified the equalisation?”.

In the example shown in FIG. 7, the user 23 that is controlling a multi-user application, such as controlling of the car stereo via an app is indicated via audio playback from the loudspeaker 25 that is closest to the user 23. Example scenarios are outlined below:
When the user 23 adds more bass, the added bass will be heard first from the closest loudspeaker 25 to them.
When the user 23 changes a radio channel, the radio channel is first heard from the loudspeaker closest to the user 23, for example, as described in relation to FIG. 6. Subsequently, other users 21, 22, 24 hear the new radio channel later.
When the user 23 previews another radio channel/stream, a preview may be played back using closest loudspeaker 25 leaving a short time to revert back to the previous radio channel/steam or, if the new radio channel/stream is selected, modify the selection before the audio extends to all other users 21, 22, 24.
When the user 23 adds a song to a playlist or otherwise interacts with the shared content (which does not change the ongoing media playback), the system 70 sounds related to the interaction may be played back only from the closest loudspeaker 25 to the currently active user 23. Depending on the modification, a further sound, may also be played back to other users 21, 22, 24. For example, a mode may be provided which provides detailed audio feedback for the active user 23 but only an acknowledgement sound to the other users 21, 22, 24.

As such, in each of these examples, the system 70 provides an environment for loudspeaker spatial audio rendering that enhances the joint content consumption experience and provide clear indication regarding who and/or how the content has been interacted with. As such, no interaction with the system 70 is required from the other users 21, 22, 24. This is especially useful for the driver who is concentrating on driver and is unable to engage with a user interface or mobile device.

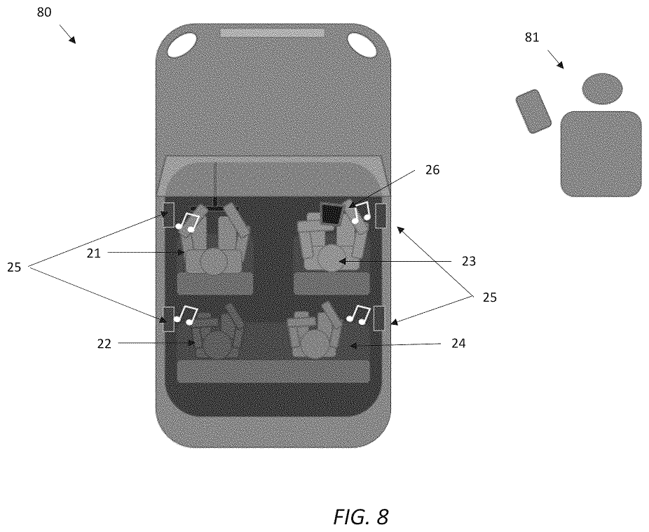

FIG. 8 shows an example connected car entertainment system 80 where a user 81 remote from the system 80 is interacting with the system 80, such that that the remote user (i.e. a second user) is not located within the environment. For example, a remote user 81 outside of the car has added songs to the playlist. The system 80 comprises means for receiving a second audio signal command from the remote user 81 and means for determining that the remote user 81 is not within the environment (e.g. via radio confirmation or geolocation). The system 80 further comprises means for modifying the audio output from at least one loudspeaker 25 based on the second audio signal command and the determination that the user is remote. Furthermore, the system 80 may further comprise implementing an audio indicator based on the determination that the second user is remote from the audio entertainment system. The audio indicator may signify that the second audio signal command was received from a remote user 81. The audio indicator may comprise at least one of: a sound effect, a change in at least one audio feature, and/or a filter implemented over the audio output. A change in the audio feature may comprise altering any audio feature as previously described. An example includes, but is not limited to, when a song starts to play, an effect is added to the start of the song. This may be, for example, an equilibrium fade from low-pass to regular playback. For example, the audio indicator may first start with an low-pass filtered (or some other effect) version of the song and then fade to a normal version of the song. In this scenario there may be two audio signals, one is the low-passed version of a song and the second signal is the original version of a song. Then cross-fade is implemented between the first signal to the second signal. First, only the low-passed version (first signal) is output from at least one loudspeaker. Then over the course of a couple of seconds the volume of the low-passed version (first signal is) is lowered to 0 and the volume of the original song (second signal) is increased to 1.

The system 80 may further comprise means for informing the remote user 81 that the second audio signal command has been implemented. For example, a signal may be transmitted from the system 80 to the remote user 81 to indicate that the second audio signal command has been received by the system 80 and implemented.

The system of FIG. 8. enables a remote user 81 together with local users 21, 22, 23, 24 to interact in a multi-user setup. In this scenario the local users 21, 22, 23, 24 may be set up according to the system defined in FIG. 6 or 7. When a remote user 81 performs interactions, e.g., change a song which is then played in the car but also for the remote user, the persons inside the car will get a different audio experience indicating interaction and modification of content played using the loudspeakers inside the car.

By way of further example, the local users 21, 22, 23, 24 in the car may be consuming content jointly with at least one remote user 81 outside of the car (such as the shared watching of a video with friends). All users 21, 22, 23, 24, 81 may control the content consumption (play, pause, rewind, make comments etc.). Audio effects related to the control are rendered depending on who is performing the control. In the case that a local user 21, 22, 23, 24 is performing the control an audio effect will be played from the closest loudspeaker 25 to the user making the control interaction. Alternatively, in the case that the remote user 81 is performing the control, an audio effect will be played from all loudspeakers 25 if the user is not in the car. Examples include, but are not limited to:
A chat message may be received from a remote user 81 not in a car, but directed to someone in the car. The notification of the chat message may rendered from the closest loudspeaker 25 to the intended recipient of the chat message.
A pausing of the video is indicated with an audio prompt from the closest loudspeaker that to the person clicking pause.
A resuming of playback may be done in a similar manner as described in relation to FIG. 6. The audio is first played from the loudspeaker closest to the person clicking play.

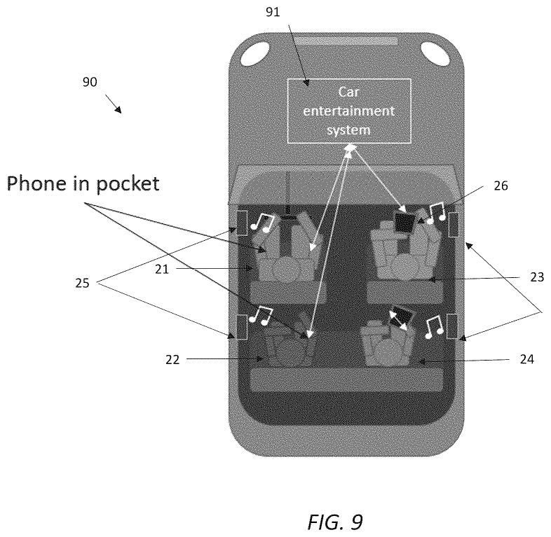

As described previously the systems 60, 70, 80 as discussed in relation FIGS. 6 to 8 handle the playback of the audio by recognizing and positioning of the user's as well as assigning loudspeakers 25 to users 21, 22, 23, 24. FIG. 9 shows a system 90 for how the position of a user in the car may be determined.

The users 21, 22, 23, 24 may be positioned by using a device that is associated with a user. As such, a first user 21 may have a first device assigned (e.g. a mobile phone) and a the same applies for each subsequent user in the environment. The mobile phone may, for example, be located in a user's pocket as shown in FIG. 9.

In some embodiments, determining the location of the first user in the environment may comprise manually informing the apparatus (e.g. the audio entertainment system) of the location of a first device in the environment, for example, by user command. The position of each user 21, 22, 23, 24 may be fixed and each user may accordingly sit in the same position each time they enter the environment.

In some embodiments, determining the location of the first user in the environment may comprise using radio signal-strength based triangulation to determine the location of the first device in the environment. In some embodiments, determining the location of the first user in the environment may comprise using Bluetooth and/or Bluetooth low energy, LE, signal-strength based triangulation to determine the location of the first device in the environment. For example, the users 21, 22, 23, 24 may be identified as they enter the environment based on Bluetooth address the users 21, 22, 23, 24 have previously signed up for the system and the car entertainment system 91 keeps track of Bluetooth IDs and usernames. Thus, as the users 21, 22, 23, 24 enter the environment, their user ID and position inside the environment is known.

In some embodiments, determining the location of the first user in the environment may comprise, using ultra-wide band, UWB, positioning technology to determine the location of the first device in the environment. Alternatively, any other type of positioning technology may be used.

In some embodiments, determining the location of the first user in the environment may comprise, using a camera located within the environment to determine the location of a user. The camera may be capable of tracking a user's position and where different users are located. This may be used alongside face recognition systems to determine where a user is located. The camera may work independently or can be used to corroborate location information determined via other methods such as Bluetooth.

The users 21, 22, 23, 24 may be identified as they enter the car based on any of these methods. Thus, as the users enter the car, their user ID and position inside the car is known.

For each user 21, 22, 23, 24, the closest loudspeaker 25 to them is identified and assigned. This is done based on the user 21, 22, 23, 24 position determined in the previous step and the known (to the car entertainment system 91) positions of the loudspeakers 25 in the environment.

In some implementations, one loudspeaker 25 may be assigned to multiple users 21, 22, 23, 24 in case of suboptimal loudspeaker setup. In this case a different audio output variation may be used to identify the users, e.g., tone/EQ change. In the case of a remote user not inside the car, no single loudspeaker is assigned to this remote user.

### Example Apparatus

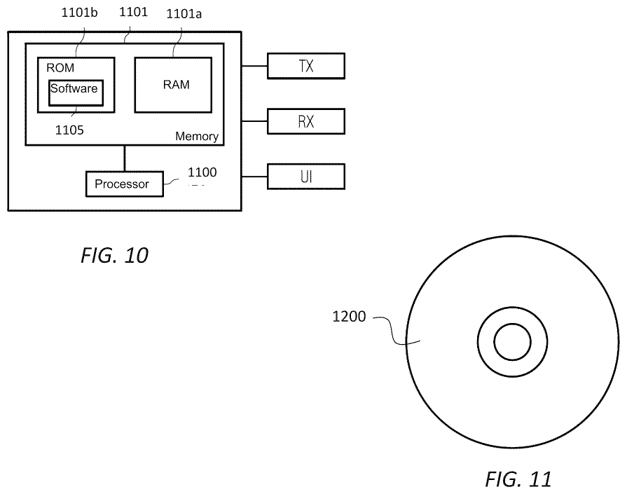

FIG. 10 shows an apparatus according to some example embodiments, which may comprise the controller 12 of FIG. 1. The apparatus may be configured to perform the operations described herein, for example operations described with reference to any disclosed process. The apparatus comprises at least one processor 1100 and at least one memory 1101 directly or closely connected to the processor. The memory 1101 includes at least one random access memory (RAM) 1101a and at least one read-only memory (ROM) 1101b. Computer program code (software) 1105 is stored in the ROM 1101b. The apparatus may be connected to a transmitter (TX) and a receiver (RX). The apparatus may, optionally, be connected with a user interface (UI) for instructing the apparatus and/or for outputting data. The at least one processor 1100, with the at least one memory 1101 and the computer program code 1105 are arranged to cause the apparatus to at least perform at least the method according to any preceding process, for example as disclosed in relation to the flow diagrams of FIG. 5 and related features thereof.

FIG. 11 shows a non-transitory media 1200 according to some embodiments. The non-transitory media 1200 is a computer readable storage medium. It may be e.g. a CD, a DVD, a USB stick, a blue ray disk, etc. The non-transitory media 1200 stores computer program code, causing an apparatus to perform the method of any preceding process for example as disclosed in relation to the flow diagrams and related features thereof.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as WiFi.

A memory may be volatile or non-volatile. It may be e.g. a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above-described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1-21. (canceled)

22. An apparatus comprising:
at least one processor; and
at least one memory storing instructions that, when executed by the at least one processor, cause the apparatus at least to:
receive, from a first user, a first audio signal command;
determine a location of the first user in an environment;
select at least a first loudspeaker from a plurality of loudspeakers located in the environment, the at least first loudspeaker being one or more loudspeakers in closest physical proximity to the first user; and
modify an audio output from the at least first loudspeaker of the plurality of loudspeakers based on the first audio signal command, such that the at least first loudspeaker has a different audio output to a remainder of the plurality of loudspeakers.

23. The apparatus of claim 22, wherein modifying the audio output from the at least first loudspeaker comprises changing at least one feature of the audio output.

24. The apparatus of claim 23, wherein the at least one audio feature comprises at least one of the following: volume, bass, treble, balance or equalization parameters.

25. The apparatus of claim 22, wherein the apparatus is further caused to:
modify a second audio output from at least a second loudspeaker of the plurality of loudspeakers, wherein the second audio output is modified such that is different to the audio output.

26. The apparatus of claim 22, wherein modifying the audio output from the at least first loudspeaker comprises playing a specific piece of audio.

27. The apparatus of claim 26, wherein the specific piece of audio comprises at least one piece of audio selected by the first user.

28. The apparatus of claim 22, wherein modifying the audio output from the at least first loudspeaker comprises playing, pausing, muting, unmuting, rewinding or fast-forwarding the audio output.

29. The apparatus of claim 22, wherein the apparatus is further caused to:
rank each of the plurality of loudspeakers according to the proximal physical distance from the first user to produce a list; and
implement the first audio signal command according to the order of the list.

30. The apparatus of claim 22, wherein the apparatus is further caused to:
receive a second audio signal command from a second user;
determine that the second user is remote from an audio entertainment system such that the second user is not located within the environment;
modify the audio output from at least one loudspeaker based on the second audio signal command; and
implement an audio indicator based on the determination that the second user is remote from the audio entertainment system.

31. The apparatus of claim 30, wherein the audio indicator comprises at least one of:
a sound effect, a change in at least one audio feature, or a filter implemented over the audio output.

32. The apparatus of claim 30, wherein the apparatus is further caused to:
inform the second user that the second audio signal command has been implemented.

33. The apparatus of claim 22, wherein determining a location of a first user in an environment comprises determining a location of a first device in the environment, wherein the first device is associated to the first user.

34. The apparatus of claim 33, wherein determining the location of the first user in the environment comprises at least one of the following:
informing the audio entertainment system of the location of the first device in the environment by user command;
using radio signal-strength based triangulation to determine the location of the first device in the environment;
using Bluetooth or Bluetooth Low Energy signal-strength based triangulation to determine the location of the first device in the environment; or
using Ultra Wide Band positioning technology to determine the location of the first device in the environment.

35. The apparatus of claim 22, wherein determining a location of the first user in an environment, comprises at least one camera configured to locate the position of the first user.

36. The apparatus of claim 22, wherein determining that the first loudspeaker is one or more loudspeakers in closest proximity to the first user is based on the determined location of a first device in the environment and positions of loudspeakers in the environment.

37. The apparatus of claim 22, wherein the apparatus is an audio entertainment system or comprises an audio entertainment system.

38. The apparatus of claim 22, wherein the apparatus is for a vehicle and the environment comprises the inside of the vehicle.

39. A method, comprising:
receiving, from a first user, a first audio signal command;
determining a location of the first user in an environment;
selecting at least a first loudspeaker from a plurality of loudspeakers located in the environment, the at least first loudspeaker being one or more loudspeakers in closest physical proximity to the first user; and
modifying an audio output from the at least first loudspeaker of the plurality of loudspeakers based on the first audio signal command, such that the at least first loudspeaker has a different audio output to a remainder of the plurality of loudspeakers.

40. A non-transitory computer readable medium comprising program instructions stored thereon for performing at least the following:
receiving, from a first user, a first audio signal command;
determining a location of the first user in an environment;
selecting at least a first loudspeaker from a plurality of loudspeakers located in the environment, the at least first loudspeaker being one or more loudspeakers in closest physical proximity to the first user; and
modifying an audio output from at least one loudspeaker from the at least first loudspeaker of the plurality of loudspeakers based on the first audio signal command, such that the at least first loudspeaker has a different audio output to a remainder of the plurality of loudspeakers.
